(19) United States
(12) Patent Application Publication
(10) Pub. No.: US 2023/0121850 A1
(43) Pub. Date: Apr. 20, 2023

(54) CONNECTED DISHWASHER AND WATER HEATER APPLIANCES

(71) Applicant: Haier US Appliance Solutions, Inc., Wilmington, DE (US)

(72) Inventors: Michael Robin Blackwood, Louisville, KY (US); Ryan Michael Newquist, Louisville, KY (US); Patrick Glen Hall, Louisville, KY (US)

(21) Appl. No.: 17/504,969

(22) Filed: Oct. 19, 2021

(51) Int. Cl. A47L 15/00; F24H 9/20; A47L 15/42; G05B 15/02

(52) U.S. Cl. CPC A47L 15/0063; F24H 9/2007; A47L 15/0023; A47L 15/0026; A47L 15/4285; A47L 15/4287; A47L 15/4244; G05B 15/02; F24H 1/18

(57) ABSTRACT

A method for operating a dishwasher appliance includes receiving data indicating a status of hot water within a water heater appliance, receiving data indicating a status for a cycle of a dishwasher appliance, and initiating a start for the cycle of the dishwasher appliance in response to the data indicating the status of hot water within the water heater appliance indicating available hot water.

### FIELD OF THE INVENTION

The present subject matter relates generally to connected appliances, in particular dishwasher appliances and water heater appliances.

### BACKGROUND OF THE INVENTION

Dishwashers require hot water for optimal wash and dry performance. Dishwashers are generally connected to a water heater via a building plumbing system, and hot water from the water heater can flow to the dishwasher through the plumbing system. However, certain water heaters heat a volume of hot water to a set temperature. As the volume of hot water is depleted, cold water enters the water heater, and the water heater heats the cold water to the set temperature over a period of time. Thus, the water heater may be unable to supply suitably hot water to the dishwasher at certain times, such as immediately after the hot water within the water heater is depleted.

During operation, dishwashers may require hot water. If hot water from the water heater is unavailable, the dishwasher may use a heating element within the dishwasher to heat water to the desired temperature. Such internal heating with the dishwasher's heating element may negatively impact an energy efficiency rating of the dishwasher. Moreover, low water temperature may also negatively impact dry performance. In general, consumer satisfaction with dishwasher performance may be negatively affected when the dishwasher is not supplied with hot water.

### BRIEF DESCRIPTION OF THE INVENTION

Aspects and advantages of the invention will be set forth in part in the following description, or may be apparent from the description, or may be learned through practice of the invention.

In an example embodiment, a computer implemented method for operating a dishwasher appliance includes receiving, using the one or more processors, data indicating a status of hot water within a water heater appliance, receiving, using the one or more processors, data indicating a status for a cycle of a dishwasher appliance, and initiating, using the one or more processors, a start for the cycle of the dishwasher appliance in response to the data indicating the status of hot water within the water heater appliance indicating available hot water.

In another example embodiment, a connected system for a dishwasher appliance and a water heater appliance that are in communication via a wireless network. The system includes one or more processors and one or more non-transitory computer-readable media storing instructions that, when executed by the one or more processors, cause the computing system to perform operations. The operations include receiving data indicating a status of hot water within the water heater appliance, receiving data indicating a status for a cycle of the dishwasher appliance, and initiating a start for the cycle of the dishwasher appliance in response to the data indicating the status of hot water within the water heater appliance indicating available hot water.

In another example embodiment, one or more tangible, non-transitory, computer readable media storing instructions that when executed by the one or more processors cause the computing system to perform operations including receiving data indicating a status of hot water within the water heater appliance, receiving data indicating a status for a cycle of the dishwasher appliance, and initiating a start for the cycle of the dishwasher appliance in response to the data indicating the status of hot water within the water heater appliance indicating available hot water.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a schematic view of a connected system for a dishwasher appliance and a water heater appliance according to an example embodiment of the present subject matter.

FIG. 2 is a schematic view of certain components of the example dishwasher appliance and the example water heater appliance of FIG. 1.

FIG. 3 shows a method according to an example embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

As used herein, the term “article” may refer to, but need not be limited to dishes, pots, pans, silverware, and other cooking utensils and items that can be cleaned in a dishwasher. The term “fill cycle” is intended to refer to one or more periods of time during which water is added to the dishwasher, e.g., by opening a valve to permit pressurized water from a plumbing system to flow into the dishwasher. The term “wash cycle” is intended to refer to one or more periods of time during which a dishwasher operates while containing the articles to be washed and uses a detergent and water to, e.g., remove soil particles including food and other undesirable elements from the articles. The term “rinse cycle” is intended to refer to one or more periods of time during which the dishwasher operates to remove residual soil, detergents, and other undesirable elements that were retained by the articles after completion of the wash cycle. The term “drain cycle” is intended to refer to one or more periods of time during which the dishwasher operates to discharge soiled water from the dishwasher. The term “wash fluid” refers to a liquid used for washing and/or rinsing the articles and is typically made up of water that may include other additives such as detergent or other treatments.

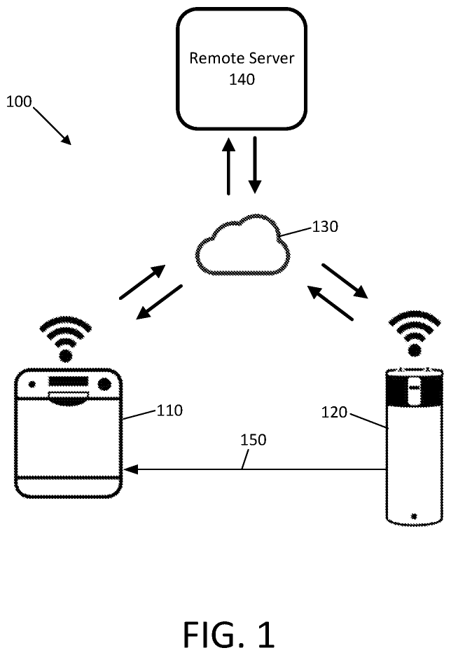

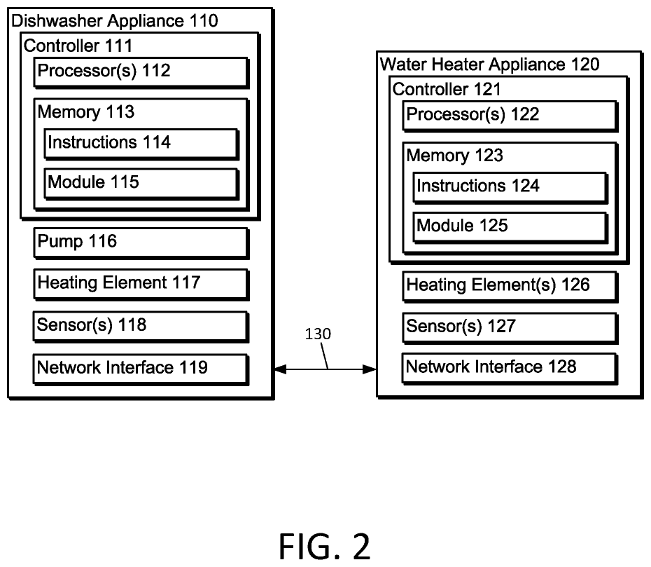

FIG. 1 is a schematic view of a connected system 100 according to an example aspect of the present subject matter. Connected system 100 includes a dishwasher appliance 110 and a water heater appliance 120. FIG. 2 is a schematic view of certain components of dishwasher appliance 110 and water heater appliance 120. As discussed in greater detail below, connected system 100 is configured for utilizing data from water heater appliance 120 to ensure that dishwasher appliance 110 is supplied with hot water from water heater appliance 120 during one or more cycles of dishwasher appliance 110.

Dishwasher appliance 110 and water heater appliance 120 are connectable to a network 130. Thus, e.g., dishwasher appliance 110 and/or water heater appliance 120 may communicate with each other and a remote server 140 via network 130. In particular, dishwasher appliance 110 may transmit data to and receive data from water heater appliance 120 via network 130, and water heater appliance 120 may transmit data to and receive data from dishwasher appliance 110 via network 130. Further, dishwasher appliance 110 and water heater appliance 120 may transmit data to and receive data from remote server 140 via network 130. To connect to network 130, dishwasher appliance 110 includes a network interface 119, and water heater appliance 120 includes a network interface 128. Network interfaces 119, 128 may each include any suitable components for interfacing with one more networks, such as network 130. For example, network interfaces 119, 128 may include transmitters, receivers, ports, controllers, antennas, or other suitable components.

Network interface 119, 128 may establish communication with network 130 via a connection through any suitable medium, e.g., wired or wireless. Network 130 may be any type of communications network, such as a local area network (e.g. intranet), wide area network (e.g. Internet), a cellular network, or some combination thereof. In general, communication between a controller 111 of dishwasher appliance 110, a controller 121 of water heater appliance 120, remote server 140, and network 130 may be carried via associated network interfaces using any type of connection, using a variety of communication protocols (e.g. TCP/IP, HTTP), encodings or formats (e.g. HTML, XML), and/or protection schemes (e.g. VPN, secure HTTP, SSL). In particular, the network 130 may be a wireless local area network (WLAN) configured to conform to IEEE 802.11.

Controller 111 of dishwasher appliance 110 may include one or more processors 112 and a memory 113. Controller 111 may be configured to implement various programs or methods to operate dishwasher appliance 110. Input/output (“I/O”) signals may be routed between controller 111 and various operational components of dishwasher appliance 110 along wiring harnesses that may be routed within dishwasher appliance 110. The operational components of dishwasher appliance 110 may include a pump 116, a heating element 117, and one or more sensor 118.

The processor(s) 112 of dishwasher appliance 110 can be any suitable processing device, such as a microprocessor, microcontroller, integrated circuit, or other suitable processing device. The memory 113 of dishwasher appliance 110 can include any suitable computing system or media, including, but not limited to, non-transitory computer-readable media, RAM, ROM, hard drives, flash drives, or other memory devices. The memory 113 of dishwasher appliance 110 can store information accessible by processor(s) 112 of dishwasher appliance 110, including instructions 114 that can be executed by processor(s) 112 to control various components of dishwasher appliance 110 to provide appliance functionality. Processor(s) 112 and memory 113 of dishwasher appliance 110 may be mounted on one or more printed circuit boards (PCBs).

In the same or similar manner to that described above for dishwasher appliance 110, controller 121 of water heater appliance 120 may include one or more processors 122 and a memory 123. Controller 121 may be configured to implement various programs or methods to operate water heater appliance 120. Input/output (“I/O”) signals may be routed between controller 121 and various operational components of water heater appliance 120 along wiring harnesses that may be routed within water heater appliance 120. The operational components of water heater appliance 120 may include one or more heating elements 126 and one or more sensor 127.

The processor(s) 122 of water heater appliance 120 can be any suitable processing device, such as a microprocessor, microcontroller, integrated circuit, or other suitable processing device. The memory 123 of water heater appliance 120 can include any suitable computing system or media, including, but not limited to, non-transitory computer-readable media, RAM, ROM, hard drives, flash drives, or other memory devices. The memory 123 of water heater appliance 120 can store information accessible by processor(s) 122 of water heater appliance 120, including instructions 124 that can be executed by processor(s) 122 to control various components of water heater appliance 120 to provide appliance functionality. Processor(s) 122 and memory 123 of water heater appliance 120 may be mounted on one or more printed circuit boards (PCBs).

A module 115 is included or stored in memory 113 of dishwasher appliance 110. Similarly, a module 115 is included or stored in memory 123 of water heater appliance 120. It will be appreciated that the term “module” refers to computer logic utilized to provide desired functionality. Thus, a module can be implemented in hardware, application specific circuits, firmware and/or software controlling a general purpose processor. In one embodiment, modules are program code files stored on the storage device, loaded into memory and executed by a processor or can be provided from computer program products, for example computer executable instructions, that are stored in a tangible computer-readable storage medium such as RAM, hard disk or optical or magnetic media. Thus, while modules 115 are shown stored in memory 113 of dishwasher appliance 110 and modules 125 are shown stored in memory 123 of water heater appliance 120 in the example embodiment shown in FIG. 2, modules 115, 125 may be stored in or implemented by any other suitable component of system 100 in alternative example embodiments.

As noted above, remote server 140 may be in communication with dishwasher appliance 110 and/or water heater appliance 120 through network 130. In this regard, for example, remote server 140 may be configured for sending and receiving data from dishwasher appliance 110 and water heater appliance 120 via network 130. For instance, remote server 140 may be a cloud-based server and is thus located at a distant location, such as in a separate city, state, country, etc. In general, communication between the remote server 140 and the client devices may be carried via a network interface using any type of wireless connection, using a variety of communication protocols (e.g. TCP/IP, HTTP, SMTP, FTP), encodings or formats (e.g. HTML, XML), and/or protection schemes (e.g. VPN, secure HTTP, SSL).

Dishwasher appliance 110 may also include a user interface panel (not shown) located within convenient reach of a user of dishwasher appliance 110. The user interface panel includes various input components, such as one or more of a variety of touch-type controls, electrical, mechanical or electro-mechanical input devices including knobs, rotary dials, push buttons, and touch pads. The user interface panel may include a display component, such as a digital or analog display device, designed to provide operational feedback to a user. Various appliance features of dishwasher appliance 110 may be activated/deactivated by a user manipulating the input components on the user interface panel. Thus, e.g., a user may manipulate knobs or buttons on the user interface panel of dishwasher appliance 110 to start washing of articles within dishwasher appliance 110.

In general, dishwasher appliance 110 may clean articles within dishwasher appliance 110 using various cycles. For instance, dishwasher appliance 110 may operate in one or more of a fill cycle, a wash cycle, a rinse cycle, and a drain cycle clean the articles within dishwasher appliance 110. Operation of dishwasher appliances, such as dishwasher appliance 110, and the cycles that make up operation of dishwasher appliance are generally understood by one of ordinary skill in the art and are not described in extensive detail herein for the sake of brevity. During certain cycles, hot water may facilitate cleaning of the articles within dishwasher appliance 110.

Water heater appliance 120 is operable to generate hot water. For instance, heating element(s) 126, such as an electric resistance heating elements, a heat pump, a gas burner, etc., may operate to heat water to a set temperature. Water heater appliances, such as water heater appliance 120, are typically set to heat water in a tank to temperatures above approximately fifty degrees Celsius (50° C.). Thus, hot water exiting water heater appliance 120 may be no less than fifty degrees Celsius (50° C.) in certain example embodiments. Operation of water heater appliances, such as water heater appliance 120, is generally understood by one of ordinary skill in the art and is not described in extensive detail herein for the sake of brevity.

From water heater appliance 120, hot water may flow to dishwasher appliance 110 via a plumbing system 150, such as pipes, conduits, tubing, etc. As noted above, the hot water from water heater appliance 120 may facilitate cleaning of the articles within dishwasher appliance 110 during certain cycles. However, after large hot water draws, heating element(s) 126 may require a period of time to heat water to the set temperature. Thus, hot water from water heater appliance 120 may be unavailable at dishwasher appliance 110 at certain times. As described in greater detail below, connected system 100 is configured for utilizing data from water heater appliance 120 to ensure that dishwasher appliance 110 is supplied with hot water from water heater appliance 120 during one or more cycles of dishwasher appliance 110.

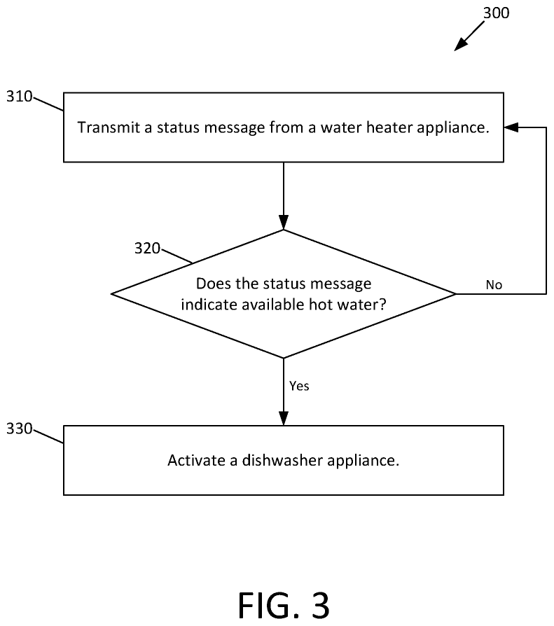

Referring now to FIG. 3, a flow diagram of a method 300 for operating a dishwasher appliance is illustrated. Method 300 will generally be described with reference to connected system 100 described with reference to FIGS. 1 and 2. For instance, method 300 may be at least partially executed by controller 111 of dishwasher appliance 110, controller 121 of water heater appliance 120, and/or remote server 140. However, method 300 may be suitable for use with any other suitable connected appliance system. In addition, although FIG. 3 depict steps performed in a particular order for purposes of illustration and discussion, the methods and algorithms discussed herein are not limited to any particular order or arrangement. One skilled in the art, using the disclosures provided herein, will appreciate that various steps of the methods and algorithms disclosed herein can be omitted, rearranged, combined, and/or adapted in various ways without deviating from the scope of the present disclosure.

At 310, controller 121 of water heater appliance 120 may transmit a status message. For example, the status message may be transmitted to one or both of controller 111 of dishwasher appliance 110 and remote server 140 via network 130 at 310. In particular, controller 121 of water heater appliance 120 may collect data indicating a status of hot water within water heater appliance 120 via sensor(s) 127 of water heater appliance 120. After collecting the data indicating the status of hot water within water heater appliance 120, the data may be formatted as the status message and transmitted from network interface 128 of water heater appliance 120 over network 130 to one or both of controller 111 of dishwasher appliance 110 and remote server 140. Thus, e.g., controller 111 of dishwasher appliance 110 may receive the status message, e.g., with the data indicating the status of hot water within water heater appliance 120, via network interface 119 from water heater appliance 120 and/or remote server 140 at 310.

The data indicating the status of hot water within water heater appliance 120 may include one or both of a temperature of hot water within water heater appliance 120 and a volume of hot water within water heater appliance 120. Thus, e.g., the data indicating the status of hot water within water heater appliance 120 may generally correspond to the temperature and/or capacity of water heater appliance 120 and indicate whether water heater appliance 120 contains hot water and thus can supply hot water to dishwasher appliance 110.

At 320, it is determined whether the status message indicates that hot water is available for dishwasher appliance 110, e.g., by one or more of controller 111 of dishwasher appliance 110, controller 121 of water heater appliance 120, and remote server 140. Moreover, as noted above, the data indicating the status of hot water within water heater appliance 120 may indicate whether water heater appliance 120 contains hot water and thus can supply hot water to dishwasher appliance 110. When the capacity of hot water within water heater appliance 120 is insufficient to supply hot water to dishwasher appliance 110, method 300 may loop back to 310, and method 300 may continue to monitor the status of hot water within water heater appliance 120 until the capacity of hot water within water heater appliance 120 is sufficient to supply hot water to dishwasher appliance 110. As a particular example, dishwasher appliance 110 may require no less than a predetermined volume of hot water, e.g., no less than eleven liters (11 L), from water heater appliance 120 for the fill cycle, the rinse cycle, etc. When water heater appliance 120 does not contain at least the predetermined volume of hot water, the status message indicates that hot water is unavailable for dishwasher appliance 110, and method 300 may loop back to 310 as discussed above. In contrast, when the capacity of hot water within water heater appliance 120 is sufficient to supply hot water to dishwasher appliance 110, method 300 may continue to 330. For example, when water heater appliance 120 contains at least the predetermined volume of hot water, the status message indicates that hot water is available for dishwasher appliance 110, and method 300 may continue to 330.

The determination of whether the status message indicates that hot water is available for dishwasher appliance 110 at 320 may be performed in response to receiving data indicating a status for a cycle of dishwasher appliance 110. For instance, when a user actuates a start input on the user interface panel of dishwasher appliance 110, controller 111 of dishwasher appliance 110 and/or remote server 140 may determine whether the status message from 310 indicates that hot water is available for dishwasher appliance 110. Thus, the determination at 320 may be in response to a user request for starting dishwasher appliance 110. As another example, during each cycle that requires hot water, controller 111 of dishwasher appliance 110 and/or remote server 140 may determine whether the status message from 310 indicates that hot water is available for dishwasher appliance 110. Thus, the determination at 320 may be in response to each cycle of dishwasher appliance 110 that requires hot water.

Method 300 may also include requesting adjustment of water heater appliance 120 in response to the data at 310 indicating insufficient hot water within water heater appliance 120. For instance, controller 121 of water heater appliance 120 may increase the set temperature of water heater appliance 120 and/or increase a volume of hot water maintained within water heater appliance 120. Controller 111 of dishwasher appliance 110 and/or remote server 140 may request such adjustment of water heater appliance 120 in response to the data at 310 indicating insufficient hot water within water heater appliance 120.

At 330, dishwasher appliance 110 is activated. For instance, in response to the status message indicating that hot water is available for dishwasher appliance 110 in water heater appliance 120, controller 111 of dishwasher appliance 110 and/or remote server 140 may initiate a cycle of dishwasher appliance 110, such as the fill cycle, the rinse cycle, or any other cycle of dishwasher appliance 110 that utilizes hot water. By confirming that hot water from water heater appliance 120 is available at 320 prior to activating the dishwasher appliance 110 at 330, method 300 may assist with operating dishwasher appliance 110 efficiently. Thus, e.g., heating element 117 of dishwasher appliance 110 may be deactivated and not used to heat water within a sump of dishwasher appliance 110, which can negatively affect an energy efficiency of dishwasher appliance 110, at 330.

Method 300 may also include pausing or delaying the cycle of dishwasher appliance 110 that requires hot water (e.g., the fill cycle, the rinse cycle, etc.) when suitable hot water is unavailable from water heater appliance 120. For instance, in response to the data from 310 indicating insufficient hot water, controller 111 of dishwasher appliance 110 and/or remote server 140 may pause or delay the start of the cycle, e.g., until sufficient hot water is available at water heater appliance 120. Thus, method 300 may delay the cycle of dishwasher appliance 110 until water heater appliance 110 has time to heat water within water heater appliance 120 to a suitable degree, e.g., to the set temperature.

Utilizing the present subject matter may assist with leveraging the cloud remote server 140 to receive reports from water heater appliance 120 regarding current hot water status, such as temperature and/or capacity, via suitable messages. Remote server 140 may forward the message to dishwasher appliance 110 via network 130, and dishwasher appliance 110 may utilize the current hot water status within water heater appliance 120 to adjust operation of dishwasher appliance 110, such as delaying start. It will be understood that the present subject matter need not utilize remote server 140, in certain example embodiments. Thus, e.g., dishwasher appliance 110 and water heater appliance 120 may communicate and exchange data directly via network 130 in certain example embodiments.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A computer implemented method for operating a dishwasher appliance, comprising:
receiving, using one or more processors, data indicating a status of hot water within a water heater appliance;
receiving, using the one or more processors, data indicating a status for a cycle of a dishwasher appliance; and
initiating, using the one or more processors, a start for the cycle of the dishwasher appliance in response to the data indicating the status of hot water within the water heater appliance indicating available hot water.

2. The method of claim 1, wherein the data indicating the status of hot water within the water heater appliance is received from the dishwasher appliance via a wireless network.

3. The method of claim 1, wherein the data indicating the status of hot water within the water heater appliance is received from a remote server via a wireless network.

4. The method of claim 1, wherein the data indicating the status of hot water within the water heater appliance comprises one or both of a temperature of hot water within the water heater appliance and a volume of hot water within the water heater appliance.

5. The method of claim 1, further comprising pausing, using the one or more processors, the cycle of the dishwasher appliance in response to the data indicating the status of hot water within the water heater appliance indicating insufficient hot water.

6. The method of claim 1, wherein a heating element within the dishwasher appliance deactivated and does not heat water within a sump of the dishwasher appliance at the start for the cycle of the dishwasher appliance.

7. The method of claim 1, further comprising requesting, using the one or more processors, the data indicating the status of hot water within the water heater appliance.

8. A connected system for a dishwasher appliance and a water heater appliance, the dishwasher appliance and the water heater appliance in communication via a wireless network, the system comprising:
one or more processors; and
one or more non-transitory computer-readable media storing instructions that, when executed by the one or more processors, cause the connected system to perform operations, the operations comprising
receiving data indicating a status of hot water within the water heater appliance,
receiving data indicating a status for a cycle of the dishwasher appliance, and
initiating a start for the cycle of the dishwasher appliance in response to the data indicating the status of hot water within the water heater appliance indicating available hot water.

9. The system of claim 8, wherein the data indicating the status of hot water within the water heater appliance is received from the dishwasher appliance via the wireless network.

10. The system of claim 8, wherein the data indicating the status of hot water within the water heater appliance is received from a remote server via the wireless network.

11. The system of claim 8, wherein the data indicating the status of hot water within the water heater appliance comprises one or both of a temperature of hot water within the water heater appliance and a volume of hot water within the water heater appliance.

12. The system of claim 8, wherein the operations further comprise pausing the cycle of the dishwasher appliance in response to the data indicating the status of hot water within the water heater appliance indicating insufficient hot water.

13. The system of claim 8, wherein the operations further comprise deactivating a heating element within the dishwasher appliance such that the heating element does not heat water within a sump of the dishwasher appliance at the start for the cycle of the dishwasher appliance.

14. The system of claim 8, wherein the operations further comprise requesting the data indicating the status of hot water within the water heater appliance.

15. One or more tangible, non-transitory, computer readable media storing instructions that when executed by one or more processors cause the computing system to perform operations comprising:
receiving data indicating a status of hot water within a water heater appliance;
receiving data indicating a status for a cycle of a dishwasher appliance; and
initiating a start for the cycle of the dishwasher appliance in response to the data indicating the status of hot water within the water heater appliance indicating available hot water.
